(19) United States
(12) Patent Application Publication
(10) Pub. No.: US 2006/0250810 A1
(43) Pub. Date: Nov. 9, 2006

(54) Motor vehicle headlight

(75) Inventors: Sebastien Casenave, Paris (FR); Etienne Pauty, Paris (FR)

Correspondence Address: Matthew R. Jenkins;JACOX, MECKSTROTH & JENKINS, Suite 2, 2310 Far Hills Building, Dayton, OH, 45419-1575, US

(73) Assignee: VALEO VISION

(21) Appl. No.: 11/408,680

(22) Filed: Apr. 21, 2006

(30) Foreign Application Priority Data
Apr. 22, 2005 (FR) 0504092

(51) Int. Cl. B60Q 1/04; F21V 5/04

(52) U.S. Cl. 362/538; 362/520

(57) ABSTRACT

A motor vehicle headlight of comprising a reflector, at least partly substantially in the form of an ellipsoid with a symmetry axis determined by the intersection of a first vertical plane and a first horizontal plane. The refractor is a useful portion of a spherical plano-convex lens having its optical axis merged with the symmetry axis, has a focus substantially merged with a second focus of the reflector, has a contour which has a barycentre offset by a predetermined distance with respect to the optical centre of the lens, and in that the second light flux passing through the useful portion is equal to a predetermined proportion of the first flux.

### FIELD OF THE INVENTION

The present invention concerns a motor vehicle headlight of the compact elliptical type, the front lens of which has a non-circular contour so that this lens meets given efficiency conditions although its external contour is not circular, whilst at the same time satisfying aesthetic considerations.

### BACKGROUND OF THE INVENTION

On a technical level, there exists a strong demand on the part of motor manufacturers for compact headlights having good efficiency, that is to say capable of recovering a large proportion of the light flux emitted by the source, whilst having reduced dimensions transversely to the optical axis.

The headlights best meeting these criteria are characterised by a lamp mounted at the first focus of an ellipsoid of revolution whose image formed at the second focus is projected onto the road by a convergent lens, normally plano-convex.

These so-called “elliptical” headlights in general reveal, when they are switched off, through a smooth cover, only the convex spherical external face of the lens, with a circular external contour, often surrounded by an appropriate trim.

On an aesthetic level, there also exist at the present time ever increasing demands on the part of designers concerning the final appearance of the vehicle headlights, in order to confer on them for example a characteristic appearance. This explains for example the use of trim around lenses of elliptical modules.

A headlight is also known comprising a lens with any contour, for example square, or more generally rectangular, circular, oval, ovoid or ogival, or having a contour of the square or rectangular type but with rounded edges or bevels, or any other contour, for example, from the documents EP-A-1.243.846 or EP-A-1.491.816.

However, it is a case in these documents of a lens whose front face, that is to say the one facing an observer placed in front of the vehicle, is planar, and whose rear face is cylindrical with vertical generatrices associated with a reflector with a parabolic profile, the purpose of this lens being to be able to offer a headlight which, whilst belonging technically to the family of headlights “of the parabolic type” does, when switched off, have an external appearance similar to that of a headlight “of the elliptical type”. Such a lens therefore meets characteristics and objectives other than those of the present invention.

An elliptical headlight having a narrow rectangular front face is described in the document U.S. Pat. No. 6,435,703 B2, which discloses a lens with circular plano-convex focusing modified by the omission of two lateral segments. This document provides for the portions of the reflector situated opposite the omitted lens portions also to be omitted.

However, the object of this document is essentially improvement in the aesthetic appearance of a headlight with a generally rectangular shape, in particular when it is switched on, without any consideration for the photometric pattern of the resulting light beam.

This headlight of the elliptical type for a motor vehicle comprising a lens that is non-circular in shape is therefore known from the prior art, the aesthetic appearance having been favoured to the detriment of the optical performance.

The document FR-A-2 620 984 discloses a headlight of the elliptical type comprising a convergent lens, non-circular in shape and non-coaxial with the reflector, so as to reduce the chromatic aberrations present in the vicinity of the light/dark limit of the dipped lighting beam.

It is also possible to cite the document FR 0 721 270, which describes headlights with elliptical or hyperbolic reflectors, associated with convergent or divergent half-lenses.

### SUMMARY OF THE INVENTION

The present invention is based on the revelation of the fact that, in an elliptical module for a headlight for a motor vehicle, the various parts of the lens do not all participate in the same way in the production of the emerging beam. The parts of the lens through which only light rays having a participation below a predetermined threshold pass can thus be omitted.

It is thus possible to produce a headlight of the elliptical type whose light flux emerging from the lens has the photometric characteristics required by the regulations, this lens having simultaneously an external contour other than circular. Such a lens therefore meets both the regulatory photometric pattern requirements and the desiderata of the designers.

The object of the present invention is therefore to produce a motor vehicle headlight of the type comprising:
a reflector, at least partly substantially in the form of an ellipsoid with a symmetry axis determined by the intersection of a first vertical plane and a first horizontal plane,
a light source placed in the vicinity of a first focus of the reflector,
a circular exit pupil in the reflector through which a first light flux issuing from the source passes,
a refractor placed in the pupil plane of the reflector,
the refractor being a useful portion of a convergent lens,
possessing a focus substantially merged with a second focus of the reflector,
possessing a contour which has a barycentre offset by a predetermined distance with respect to the optical center of the lens.

According to the present invention,
the optical axis of the refractor is merged with the symmetry axis,
and the second light flux passing through the useful portion is equal to a predetermined fraction of the first flux.

According to other characteristics of the invention, considered in isolation or in combination,
the barycentre of the contour is offset by a predetermined distance downwards in the said first vertical plane with respect to the optical centre of the said lens;
the barycentre of the contour is offset by a predetermined distance laterally with respect to the first vertical plane;
the predetermined fraction of the first flux passing through the refractor is at least 75% of the first flux;
the predetermined fraction of the first flux passing through the refractor is approximately 95% of the first flux;
the reflector has at least one surface element moving away from the nominal surface of the ellipsoid and a light ray reflected by the said element passes through the useful portion of the lens;
the useful portion of the lens extends on each side of the first horizontal plane between a second horizontal plane and a third horizontal plane situated at a distance from the first horizontal plane lying between ⅓ and ⅙ of the diameter of the circular exit pupil of the reflector;
the said useful portion extends on each side of the first vertical plane between a second vertical plane and a third vertical plane, each situated at a distance from the first vertical plane lying between ⅓ and ⅙ of the diameter of the circular exit lens of the reflector;
the distances between the first vertical plane and the second vertical plane or the third vertical plane are different depending on whether it is a case of a right-hand or left-hand headlight;
the said contour is chosen from amongst the group comprising a square, a hexagon, a triangle, a diamond or a parallelogram;
a shield is disposed between the reflector and the circular exit pupil of the reflector;
the shield intercepts some of the light rays before they reach the refractor in order to prevent their being found in the beam emerging from the refractor;
the shield is disposed at the second focus of the reflector, one edge of this shield passing through the symmetry axis of the reflector in order to determine a cutoff in the beam emerging from the refractor;
the convergent lens is a plano-convex lens;
the plano-convex lens is a spherical plano-convex lens;
the convergent lens is a biconvex lens;
the convergent lens is a convergent meniscus.

These few essential specifications will have made obvious to a person skilled in the art the advantages afforded by the device according to the invention compared with the prior art.

The detailed specifications of the invention are given in the following description in relation to the accompanying drawings. It should be noted that these drawings have no purpose other than to illustrate the text of the description and in no way constitute a limitation to the scope of the invention.

### BRIEF DESCRIPTION OF THE DRAWINGS

FIG. 1 is an outline diagram of the motor vehicle headlight according to the invention.

FIG. 2 illustrates, by a set of isolux curves, the distribution of light flux in the plane of a circular exit pupil of the reflector of a headlight according to the invention.

FIGS. 3A, 3B and 3C are front views of headlight refractors according to the invention having, respectively, a square, hexagonal and triangular contour.

### DESCRIPTION OF PREFERRED EMBODIMENTS OF THE INVENTION

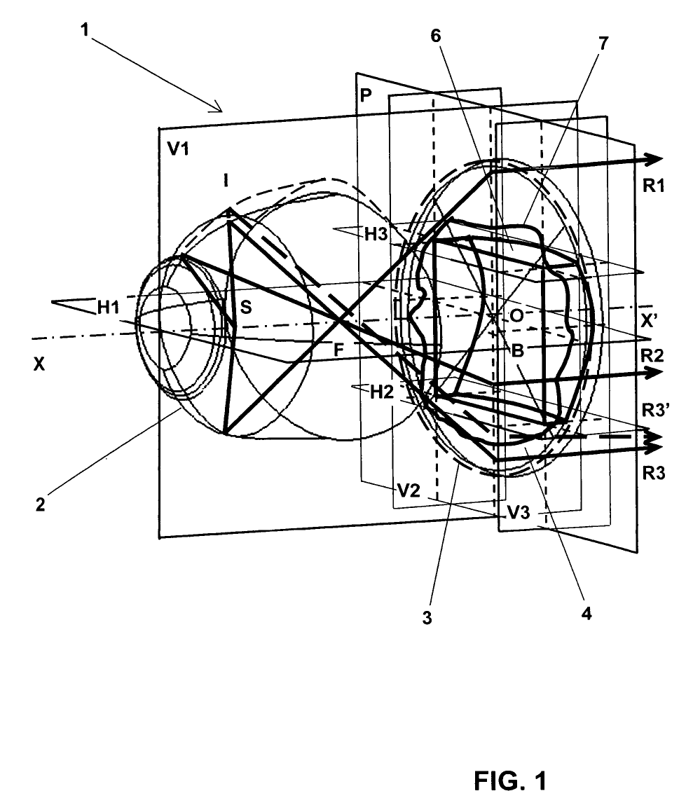

FIG. 1 shows the general principle of the invention, in the form of a wire-frame representation of the main elements of the headlight 1.

The mirror or reflector 2 is substantially an ellipsoid of revolution with a symmetry axis XX′. For simplification, it is considered that this symmetry axis XX′ is the intersection of a first vertical plane V1 and a first horizontal plane H1, corresponding approximately to the preferential arrangement of the headlight 1 in a vehicle.

The light emitted by a lamp S placed at the first focus of the mirror 2 passes through a plane P perpendicular to the symmetry axis XX′. In the remainder of the description only a circular surface 3 of this plane will be considered, centred on the line O of the symmetry axis XX′ in this plane, and corresponding to the planar entry face of a convergent lens 4 with a circular contour placed downstream of the mirror 2 in the direction of progression of the light rays.

The convergent lens 4 can consist conventionally of a plano-convex lens, whose entry face is planar and exit face convex, for example spherical or quasi-spherical. It can also consist of a biconvex lens, or a convergent meniscus.

The entry pupil of the lens 4 will in the remainder of the description be assimilated to the exit pupil of the mirror 2.

The lens 4 of circular contour is normally placed so that its planar entry face is situated in the pupil plane P and so that its object focus coincides with the second focus F of the mirror 2, so as to project onto the road the image of the light source S formed by the elliptical reflector 2 at its second focus F.

The light rays R1, R2 issuing from the source S then form a lighting beam, these rays being as a first approximation substantially parallel to the axis XX′.

Computer programs make it possible, after having indicated to them the physical characteristics of the various constituents of a catadioptric headlight system, to trace the path of the light rays issuing from the light source as far as the scene to be illuminated, or on the other hand to know the reverse path of a light ray coming to illuminate a precise point of the scene illuminated by the headlight. Such methods are called “ray casting”.

Such programs reveal that not all parts of the lens 4 contribute in the same way to the formation of the beam R1, R2.

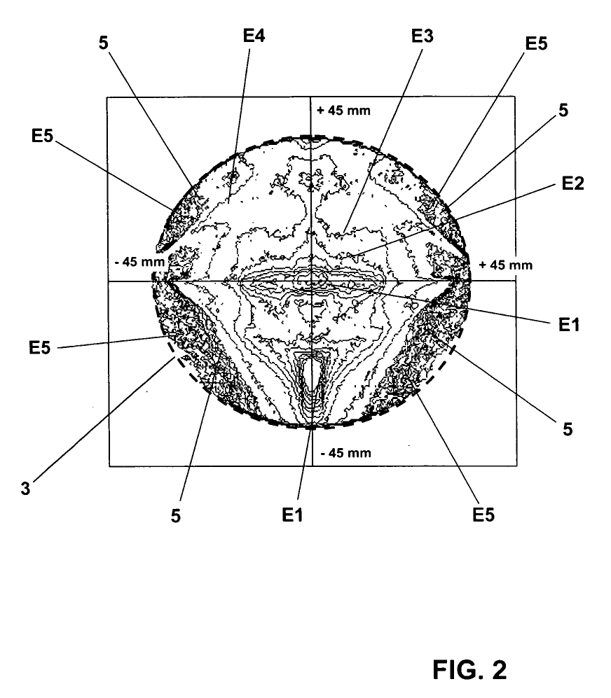

The simulated distribution of the light flux at the entry pupil of the lens 4 or the exit pupil of the reflector 2 3, 70 mm in diameter in the example in question, depicted in FIG. 2, shows in particular that certain peripheral parts 5 of the lens, having no significant isolux curves E1, E2, E3, E4, E5, contribute to less than 5% of the transmitted flux (E1 is the isolux corresponding to the strongest illumination, E5 corresponding to the weakest).

These peripheral parts 5, in particular the top segment corresponding to a top layer of the beam, participate only to a very small extent to the production of the final beam and can be omitted without the overall efficiency of the headlight 1 being effected thereby, which can also make it possible to modify the general contour of the refractor 6 and thus to act on the general aesthetic appearance of the refractor 6.

An advantage supplementary to such an omission lies in the fact that the refractor thus obtained is very substantially less heavy than the lens with a circular contour that it replaces, which makes it possible to simplify other problems, such as for example the holding of the refractor 6 with respect to the reflector 2.

In the present description, the term “refractor” is given to an optical device imparting a controlled diversion to the light rays passing through it, the entry face of which is planar, the exit face spherical, and the external contour of which is of any type. Such a “refractor” is obtained for example by means of a conventional headlight lens of the elliptical type, from which peripheral areas have been removed.

The refractor thus obtained constitutes what will be termed in the present description the “useful portion” of the original lens. It will easily be understood that the total volume of the useful portion of the original lens, constituting the final refractor, will be different according to the proportion of light flux passing through the entry pupil of the original lens that it is wished to keep at the exit from the refractor obtained.

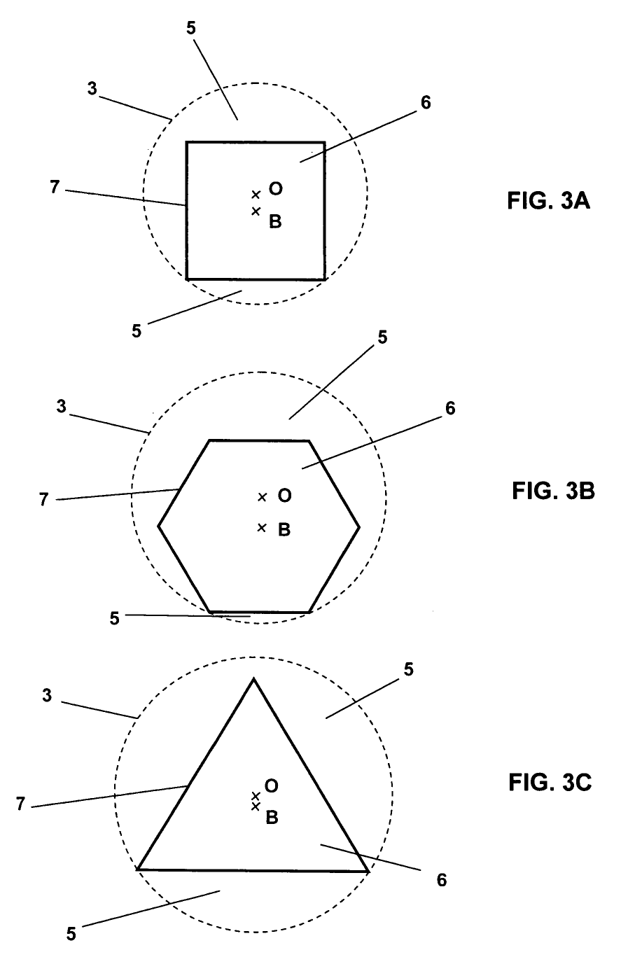

A first example of headlight according to the invention comprises part of a plano-convex lens, with a diameter of approximately 60 mm, forming a square refractor 6 approximately 36 mm square, shown in FIG. 3A.

The contour 7 of the lens 6 does not correspond to the square which would be inscribed in the circumference of the lens 4. Its side is smaller than the value that would be derived from the diameter of the lens 4 by dividing it by \sqrt{2}, so that the center B of the square 7 is offset with respect to the optical center O of the lens 4.

This amounts to keeping as a priority the bottom layers of the beam R2, as shown clearly in FIG. 1 where the barycentre B of a rectangular refractor 6, placed in the pupil plane P, is offset downwards in the first vertical plane V1.

A second example embodiment is that using a plano-convex lens part whose diameter is approximately 66 mm in order to form a refractor 6 whose contour 7 is a regular hexagon with a sides of approximately 26 mm shown in FIG. 3B.

The hexagonal contour 7 also does not correspond to that of the hexagon that would be inscribed in the pupil 3, so that the barycentre B of the contour 7 is also offset with respect to the optical center O.

In a third example depicted in FIG. 3C, the contour 7 of the refractor 6 of the headlight 1 is an isosceles triangle whose base is approximately 60 mm and height 50 mm; the lens is also a plano-convex lens whose diameter is approximately 72 mm.

This isosceles triangle does not correspond to the equilateral triangle that would be inscribed in the pupil 3: the center B of the triangle is also offset with respect to the optical center O.

The ray casting mentioned above showed that the contour 7 could be of any type provided that it preserves a minimum part of the lens 4.

The form and extent of this minimum part depends on the fraction of the light flux issuing from the light source S to be transmitted through the exit pupil 3.

Where it is wished for 95% of the flux to be transmitted, the refractor 6 must comprise at a minimum the rectangular refractor 6 shown in FIG. 1, delimited on each side of the first horizontal plane H1 and the first vertical plane V1, respectively, by second and third horizontal planes H2, H3 and by second and third vertical planes V2, V3.

The second horizontal plane H2 is shifted upwards from the first horizontal plane H1 by a distance equal to ⅙ of the diameter of the circular exit pupil 3; the third plane H3 is situated towards the bottom at a distance equal to ⅓ of this diameter.

The second and third vertical planes V2, V3 straddle the first vertical plane V1, at a distance from each other equal to ⅔ of the diameter of the pupil 3.

Other values could be chosen according to the quantity of flux that it is wished to transmit through the refractor, the minimum value not to be exceeded so that the final beam always meets the regulations being around 75%.

The ray casting method also showed that the contribution to the beam R1, R2 of certain peripheral parts of the lens 4, having absolutely to be omitted, could be reduced by modifying the nominal form of the reflector 2.

For example, FIG. 1 shows that a light ray R3 reflected at a point I on the surface of the mirror 2 in the form of an ellipsoid, and passing through the pupil 3 outside the contour 7, can be diverted along a new ray R3′, passing through the inside of the contour 7, by modifying the surface of the mirror in the vicinity of the point I.

A precise adaptation of the form of the reflector 2 to the contour of the refractor 6, dictated by the ray casting method, therefore makes it possible to increase the proportion of the light flux transmitted by this refractor 6, whatever its form.

As goes without saying, the invention is not limited solely to the preferential embodiments described above. On the contrary it embraces all possible variant embodiments.

Thus for example the examples that have been given of square, hexagonal or triangular contours can be put into practice with original lenses of any desired or appropriate diameter. Other forms are also possible, in particular a contour 7 in the form of a diamond or parallelogram, or in the form of an “inclined” square, that is to say where one side is neither vertical nor horizontal, is possible by correctly identifying the actually useful part of the lens 4.

The replacement of the peripheral parts 5 of the lens 4 which were omitted with portions of frosted or coloured glass, in order to create visual effects, and which do not impair the efficiency of the headlight 1 since the contribution of these parts to the beam R2, R3′ is small, would not be departing from the scope of the present invention, provided that the characteristics of the headlight 1 result from the following claims.

Likewise, the barycentre of a refractor can be offset towards the right or towards the left with respect to a vertical plane passing through the line O of the symmetry axis XX′ in the plane P, if it is wished to produce left and right headlights with different appearances.

While the form of apparatus herein described constitute a preferred embodiment of this invention, it is to be understood that the invention is not limited to this precise form of apparatus, and that changes may be made therein without departing from the scope of the invention which is defined in the appended claims.

What is claimed is:

1. Motor vehicle headlight of the type comprising a reflector, at least partly substantially in the form of an ellipsoid with a symmetry axis determined by the intersection of a first vertical plane and a first horizontal plane, a light source placed in the vicinity of a first focus of the reflector, a circular exit pupil in said reflector through which a first light flux issuing from said light source passes, a refractor placed in the pupil plane of the reflector, the refractor
being a useful portion of a convergent lens,
possessing a focus substantially merged with a second focus of said reflector,
possessing a contour which has a barycentre offset by a predetermined distance with respect to the optical center of said convergent lens,
wherein the optical axis of the refractor is merged with the symmetry axis, and in that the second light flux passing through said useful portion is equal a predetermined fraction of the first flux.

2. The motor vehicle headlight according to claim 1, wherein the barycentre of the contour is offset by a predetermined distance downwards in the first vertical plane with respect to the optical center of the lens.

3. The motor vehicle headlight according to claim 1, wherein the barycentre of the contour is offset by a predetermined distance laterally with respect to the first vertical plane.

4. The motor vehicle headlight according to claim 1, wherein the predetermined fraction of the first flux passing through the refractor is at least 75% of the first flux.

5. The motor vehicle headlight according to claim 4, wherein the predetermined fraction of the first flux passing through the refractor is approximately 95% of the first flux.

6. The motor vehicle headlight according to claim 1, wherein the reflector has at least one surface element moving away from the nominal surface of the ellipsoid and in that a light ray reflected by said element passes through the useful portion of the convergent lens.

7. The motor vehicle headlight according to claim 1, wherein the useful portion of the lens on each side of the first horizontal plane between a second horizontal plane and a third horizontal plane situated at a distance from the first horizontal plane lying between ⅓ and ⅙ of the diameter of the circular exit pupil of the reflector.

8. The motor vehicle headlight according to claim 1, wherein the useful portion of the lens extends on each side of the first vertical plane between a second vertical plane and a third vertical plane, each situated at a distance from the first vertical plane lying between ⅓ and ⅙ of the diameter of the circular exit lens of the reflector.

9. The motor vehicle headlight according to claim 8, wherein the distances between the first vertical plane and the second vertical plane or the third vertical plane are different depending on whether it is a case of a right-hand headlight or a left-hand headlight.

10. The motor vehicle headlight according to claim 1, wherein the contour is chosen from amongst the group comprising a square, a hexagon, a triangle, a diamond or a parallelogram.

11. The motor vehicle headlight according to claim 10, wherein the diameter of the lens is approximately 60 mm and in that the contour is a square with sides of approximately 36 mm.

12. The motor vehicle headlight according to claim 10, wherein the diameter of the lens is approximately 66 mm and in that the contour is a regular hexagon with sides of approximately 26 mm.

13. The motor vehicle headlight according to claim 10, wherein the diameter of the lens is approximately 72 mm and in that the contour is an isosceles triangle whose base is approximately 60 mm and height 50 mm.

14. The motor vehicle headlight according to claim 1, wherein a shield is disposed between the reflector and the circular exit pupil of the reflector.

15. The motor vehicle headlight according to claim 11, wherein the shield intercepts some of the light rays before they reach the refractor in order to prevent their being found in the beam emerging from the refractor.

16. The motor vehicle headlight according to claim 12, wherein the shield is disposed at the second focus of the reflector, one edge of this shield passing through the symmetry axis of the reflector in order to determine a cutoff in the beam emerging from the refractor.

17. The motor vehicle headlight according to claim 1, wherein the convergent lens is a plano-convex lens.

18. The motor vehicle headlight according to claim 1, wherein the convergent lens is a spherical plano-convex lens.

19. The motor vehicle headlight according to claim 1, wherein the convergent lens is a biconvex lens.

20. The motor vehicle headlight according to claim 1, wherein the convergent lens is a convergent meniscus.

21. A headlight lens system for use on a vehicle, said system comprising:
a first lens for receiving a first light flux from a light source and a reflector, said first lens having a first optical center; and
a refractor having a useful portion and a center which is offset from said first optical center;
said refractor receiving a second light flux from said first lens, said second light flux passing through said useful portion being a predetermined portion of said first light flux.

22. The headlight lens system as recited in claim 21 wherein said offset is a barycentre offset.

23. The headlight lens system as recited in claim 22 wherein said barycentre offset is a predetermined distance downwards with respect to said first optical center.

24. The headlight lens system as recited in claim 22 wherein said barycentre offset is a predetermined distance laterally with respect to said first optical center.

25. The headlight lens system as recited in claim 21 wherein said predetermined portion is at least 75 percent.

26. The headlight lens system as recited in claim 21 wherein said predetermined portion is at least 95 percent.

27. A method for designing a lens system for use with a headlight of a vehicle, comprising the steps of:
selecting a refractor lens having a desired contour or shape;
selecting a first lens through which a first light flux passes toward said refractor lens;
identifying a useful part of a said first lens; and
offsetting a barycentre of said contour or shape of said refractor lens from an optical center of said first lens such that said refractor uses a predetermined portion of a second light flux received from said first lens.

28. The method as recited in claim 27 wherein said barycentre offset is a predetermined distance downwards with respect to said first optical center.

29. The method as recited in claim 27 wherein said barycentre offset is a predetermined distance laterally with respect to said first optical center.

30. The method as recited in claim 27 wherein said predetermined portion is at least 75 percent.

31. The headlight lens system as recited in claim 27 wherein said predetermined portion is at least 95 percent.
